(19) United States
(12) Patent Application Publication
(10) Pub. No.: US 2013/0001383 A1
(43) Pub. Date: Jan. 3, 2013

(54) SPACED T PRIMARY MEMBER-TO-PRIMARY MEMBER CONNECTION

(76) Inventors: Puckett Jay, Laramie, WY (US); Patrick McManus, Cheyenne, WY (US)

(21) Appl. No.: 13/174,663

(22) Filed: Jun. 30, 2011

(51) Int. Cl. F16M 13/02; B23P 17/04; F16M 13/00

(52) U.S. Cl. 248/201; 248/309.1; 248/214; 29/428

(57) ABSTRACT

A connection geometry for T-shaped primary member-to-primary member connections is provided. The primary members, for example, may comprise a column, beam, brace, hanger, or the like. In one implementation, for example, a beam-to-column or column-to-beam connection may be provided. In one implementation, a primary member-to-primary member connection is provided. The connection comprises: a support bracket having a first support bracket face; a first support member comprising a first support member face for connecting to the support bracket to support a second support member; a spacer disposed between the first support bracket face and the first support member face, wherein the spacer is disposed and configured to allow deformation of the first support bracket face toward or away from the first support member face in response to a load. The deformation may comprise elastic and/or inelastic deformation.

### CROSS-REFERENCE TO RELATED APPLICATIONS

This application claims the benefit of U.S. provisional application No. 60/360,378, entitled “Shimmed WT Beam-to-Column Connection” filed by Puckett and McManus on 30 Jun. 2010, which is hereby incorporated by reference in its entirety including the appendices as though fully set forth herein.

### BACKGROUND

a. Field of the Invention

The instant invention relates to a spaced T primary member-to-primary member connection for structural load resisting systems, such as but not limited to seismic structural load resisting systems.

b. Background

A conventional WT connection 10 is illustrated in FIG. 1 (Example WT Stub Moment Connection (FEMA, 2000a)). This type of connection has been used for many years, but typically not for seismic or other loading connections designed to sustain inelastic deformation in the top and bottom WT. Typically, the WT connection (e.g., a bending connection) comprises a pair of T-shaped brackets 12 formed by cutting a wide flange (I-shaped) member, although the T-shaped brackets may be otherwise formed, such as by casting, welding, etc. The connection further shows an example shear connection 14 between the pair of T-shaped brackets 12.

FIG. 2 illustrates an example ductile WT moment connection 20 design concept that portions the WT 22 sizes to be “weaker” than the beam 24, thereby protecting the beam and column from damage. After an earthquake or other loading event, the WT can be replaced.

As the frame deforms during an earthquake or other loading event, the top and bottom WT 22 deform but independently as shown in FIG. 3 where the top WT 22 is deformed. In this Figure, the point of rotation is at point A. Because seismic loads act in both directions, when the structural frame moves in the opposite direction the bottom WT will deform and the top will move into bearing on the column flange. As in FIG. 1, FIG. 2 similarly shows a shear connection disposed between the top and bottom WT connections.

A finite element model illustrates the deformation of the WT. Note that in this connection the movement can only occur away from the column flange. See, e.g., the stress plot and deformed shape 40 for a phase 1 model in FIG. 4.

### BRIEF SUMMARY

A connection geometry for T-shaped primary member-to-primary member connections is provided. The primary members, for example, may comprise a column, beam, brace, hanger, or the like. In one implementation, for example, a beam-to-column or column-to-beam connection may be provided. The T-shaped brackets or supports, for example, may comprise WT beam-to-column connections. In one embodiment, for example, the T-shaped brackets may comprise T-shaped connections cut from wide flange (I-shaped) members (WT) or otherwise formed, such as by casting, welding, etc. Although examples are described herein with respect to WT connections, any type of T-shaped brackets may be used.

Inelastic deformations during a significant seismic event are directed into a WT flange (joint throughout the structural frame), thereby leaving the remainder of the structural frame elastic with minimal damage. This type of structural fuse is different than those presently used and those used in past applications where typically a major event requires demolition of the frame.

In one implementation, the use of spacers (e.g., shims) improves the connection performance (e.g., by a factor of two). This simple and unique extension permits the global inelastic deformation demanded by design codes for the entire structure while decreasing inelastic demand on local WT components, in some instances for example by approximately 50%. Also reduced are the forces required of other elements within the structure to develop the required WT component deformation (i.e. bolts, beams, columns, etc.). This connection is extremely economical to construct.

In one particular implementation, a T-shaped (e.g., WT) flange is used to connect a beam to a column within a structure that may encounter a seismic or other similar event. A single T-shaped flange deploys two shims to position the T-shaped flange away from the column. During a seismic event, the T-shaped flange incurs inelastic deformation between the shims. The inelastic deformation of the T-shaped flange can absorb the seismic or other load moment—preserving the elastic integrity of the beam and column.

In one particular implementation, the T-shaped flanges can be used for one, two or more primary members (e.g., beams) connected to a single other primary member (e.g., a column). In this implementation, the multiple T-shaped flanges incur inelastic deformation in a cooperative manner during a seismic event. During a seismic event, for two T-shaped flanges used cooperatively, the use of shims can decrease the inelastic deformation of the T-shaped flange by 50% from the inelastic deformation of a traditional connection.

In one implementation, a primary member-to-primary member connection is provided. The connection comprises: a support bracket having a first support bracket face; a first support member comprising a first support member face for connecting to the support bracket to support a second support member; a spacer disposed between the first support bracket face and the first support member face, wherein the spacer is disposed and configured to allow deformation of the first support bracket face toward or away from the first support member face in response to a load. The deformation may comprise elastic and/or inelastic deformation.

In one implementation, the support bracket comprises a T-shaped bracket for coupling the second support member to the first support member via the first support member face.

The T-shaped bracket, for example, may comprise one or more of the group comprising a welded T-shaped bracket, a cast T-shaped bracket, an extruded bracket, a milled bracket, a machined bracket, and a WT bracket. The load may comprise one or more of a seismic load, a blast load, a wind load, a thermal load, a gravity load, a soil load, and a displacement load due to an environmental effect.

In one specific implementation, the spacer comprises a pair of spacers. The pair of spacers, for example, may be disposed adjacent to opposing flanges of the bracket along the first support bracket face to allow the support bracket to deform along the first support bracket face toward or away from the first support member face between the pair of spacers in response to the load. The pair of spacers may further be integral with at least one of the support bracket and the first support member. The pair of spacers, for example, may comprise any type of spacer to separate the support bracket face from the first support member face, such as but not limited to a shim, a washer, a ring, a plate, a bar, a pad, and a round. The support member may be constructed of any applicable material, such as various metals, plastics, elastomeric or other types of materials.

The spacer, for example, may comprise one or more spacers that are integral with at least one of the support bracket and the first support member. Similarly the one or more spacers may comprise any type of spacer(s) to separate the support bracket face from the first support member face, such as but not limited to a shim, a washer, a ring, a plate, a bar, a pad, and a round.

In various implementations, the first support member and second support member may comprise any type of support member. For example, in on particular implementation, the first support member comprises a column and the second support member comprises a beam. In another implementation, the first support member comprises a beam and the second support member comprises a column.

In various implementations, the connection further comprises a shear connection coupling the first support member to the second support member.

In another implementation, a primary member-to-primary member connection is provided comprising: a first support member comprising opposing sides; a pair of support brackets each comprising a support bracket face, wherein each of the pair of support brackets is coupled to one of the opposing sides of the first support member; a second support member comprising a second support member face for connecting to the pair of support brackets to support the first support member; and a spacer disposed between each support bracket face of the pair of support brackets and the second support member face, wherein spacers are disposed and configured to allow deformation of at least one of the support bracket faces toward the second support member face in response to a load. The deformation may comprise elastic and/or inelastic deformation.

In one implementation, each of the pair of support brackets comprises a T-shaped bracket for coupling the first support member to the second support member via the second support member face. The T-shaped brackets, for example, may comprise one or more of the group comprising a welded T-shaped bracket, a cast T-shaped bracket, an extruded bracket, a milled bracket, a machined bracket, and a WT bracket.

In various implementations, the load comprises one or more of the group comprising a seismic load, a blast load, a wind load, a thermal load, a gravity load, a soil load, and a displacement load due to an environmental effect.

In one particular implementation, each of the spacers comprises a pair of spacers. For example, each of the pair of spacers can be disposed adjacent opposing flanges of one of the pair of support brackets along the support bracket face to allow the support bracket to deform along the first support bracket face toward the second support member face between the pair of spacers in response to the load. In one implementation, the spacers can be integral with at least one of the support brackets and the second support member.

In various implementations, the first support member and second support member may comprise any type of support member. For example, in on particular implementation, the first support member comprises a column and the second support member comprises a beam. In another implementation, the first support member comprises a beam and the second support member comprises a column.

In various implementations, the connection further comprises a shear connection coupling the first support member to the second support member.

A method of providing a primary member-to-primary member connection is also provided. In one implementation, the method comprises: coupling a pair of support brackets to opposing sides of a first support member, each of the pair of support brackets comprising a support face; and coupling the pair of support brackets to a second support member along a second support member face, wherein the support faces of the pair of support brackets are disposed generally opposing the second support member face of the second support member and the second support member face is separated from the respective support bracket faces of the pair of support brackets by at least one spacer configured to allow deformation of at least one of the support bracket faces toward the second support member face in response to a load.

In various implementations, the first support member and second support member may comprise any type of support member. For example, in on particular implementation, the first support member comprises a column and the second support member comprises a beam. In another implementation, the first support member comprises a beam and the second support member comprises a column.

In various implementations, the connection further comprises a shear connection coupling the first support member to the second support member.

The foregoing and other aspects, features, details, utilities, and advantages of the present invention will be apparent from reading the following description and reviewing the accompanying drawings.

### BRIEF DESCRIPTION OF THE DRAWINGS

FIG. 1 illustrates a conventional WT connection.

FIG. 2 illustrates an example ductile WT moment connection 20 design concept that portions the WT 22 sizes to be “weaker” than the beam 24, thereby protecting the beam and column from damage.

FIG. 3 illustrates frame deformation during a loading event.

FIG. 4 illustrates a finite element model showing deformation of a WT connection.

FIGS. 5 and 6 show an example of an extension for a beam to column connection within a structure.

FIG. 7 illustrates preliminary modeling results depicting movement of a WT away and toward the column in an example spaced connection cyclic load-deformation plot.

FIG. 8 illustrates an example specimen prior to testing.

FIG. 9 illustrates test results and associated load-deflection results.

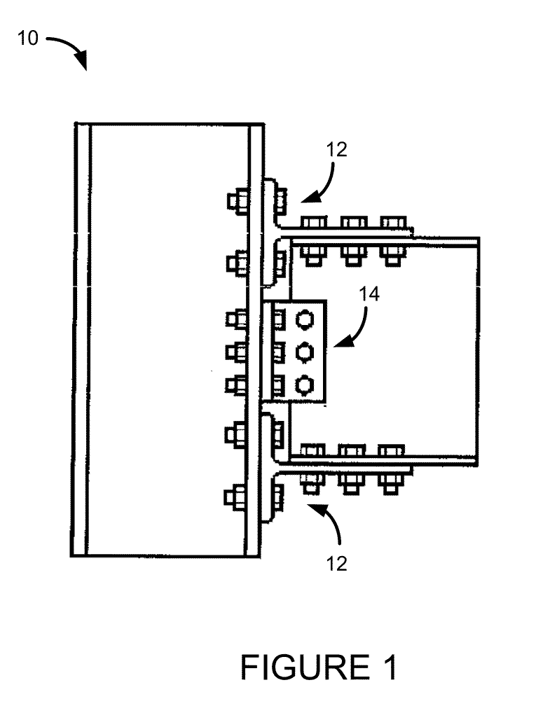

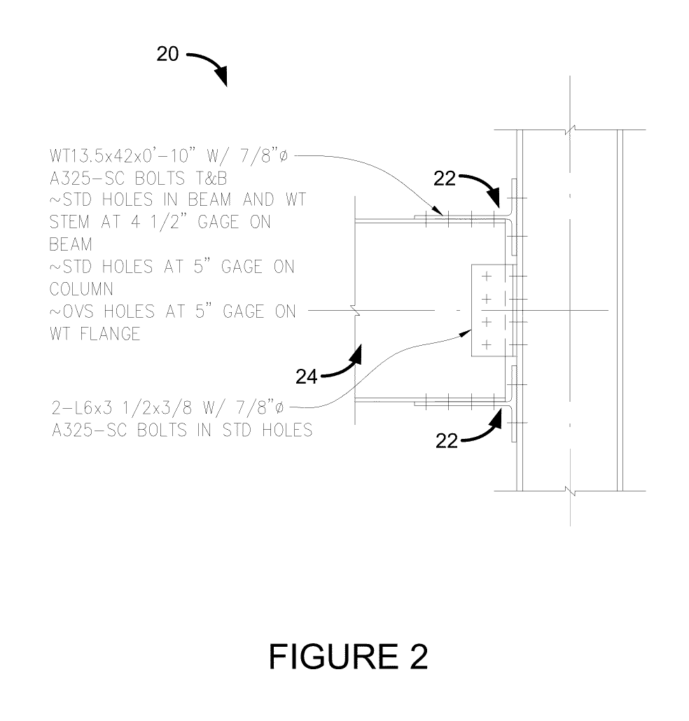

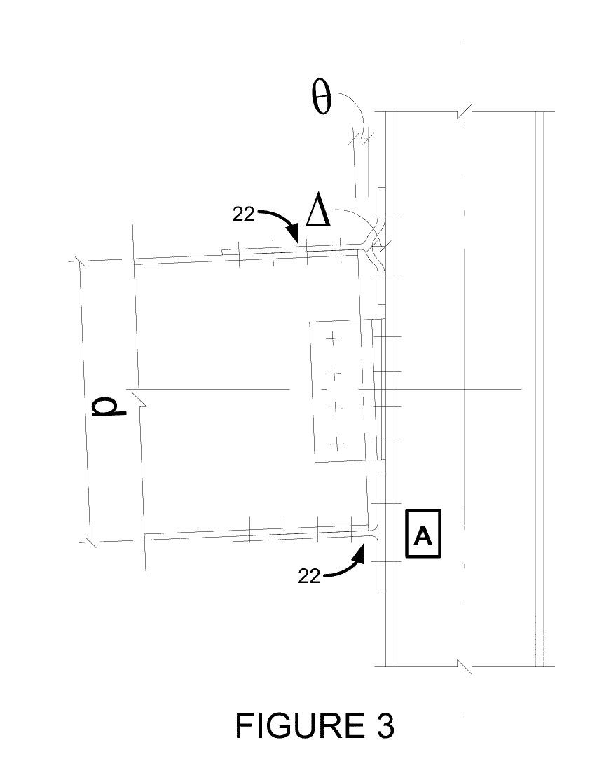

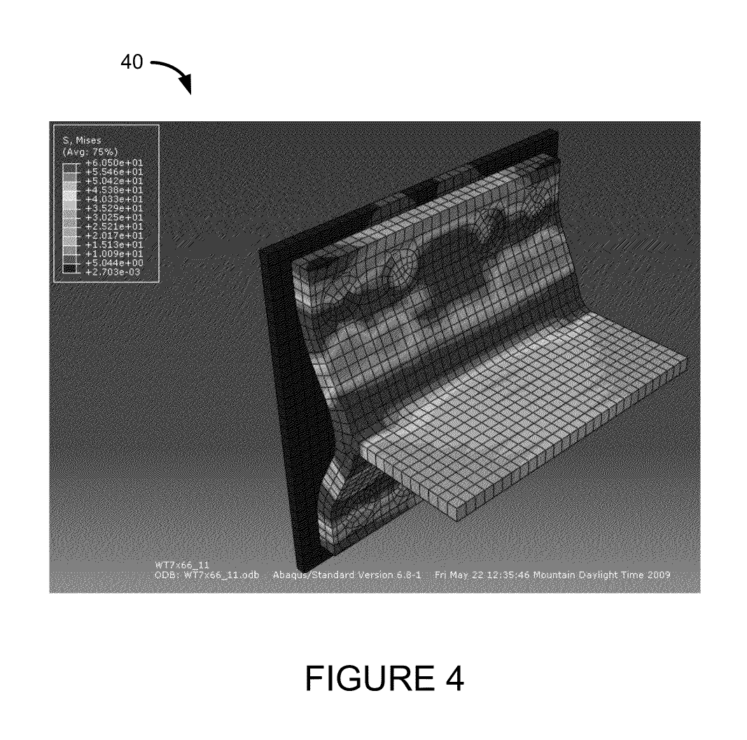

### DETAILED DESCRIPTION

In one implementation, a primary member-to-primary member connection for structural load resisting systems is provided. The primary members, for example, may comprise a column, beam, brace, hanger, or the like. In one implementation, for example, a beam-to-column or column-to-beam connection may be provided. Although examples are described herein with respect to WT connections, any type of T-shaped brackets may be used. In addition, spacers, such as but not limited to shims, may be separate or integral with one or more brackets and/or with beams to which the brackets are to be connected. Any means of separating the intersection between one or more T bracket face and a column face, such as but not limited to spacers, washers, shims, rings, plates, bars, pads, rounds, or the like may be used as a spacer to allow deformation of the T bracket face toward the column face. Similarly, although the examples described herein depict an end of a beam being connected into a face of a column, a beam may also be extended over or under a column in a configuration in which the column is attached to the beam in a similar manner as described herein with respect to an example beam being connected into the face of the column. Also, other primary support members may be interchanged with one or both of the column and beam in the described examples.

Further, while examples are described with respect to one or more specific types of loading such as seismic loading, the described connections and structural devices can be used for other types of loading such as but not limited to blast, wind, thermal, gravity, soil loads, including those resulting from soil or other environmental displacements, and the like.

While bending connections are described in detail, any type of shear connection may be used in combination with the disclosed bending connections.

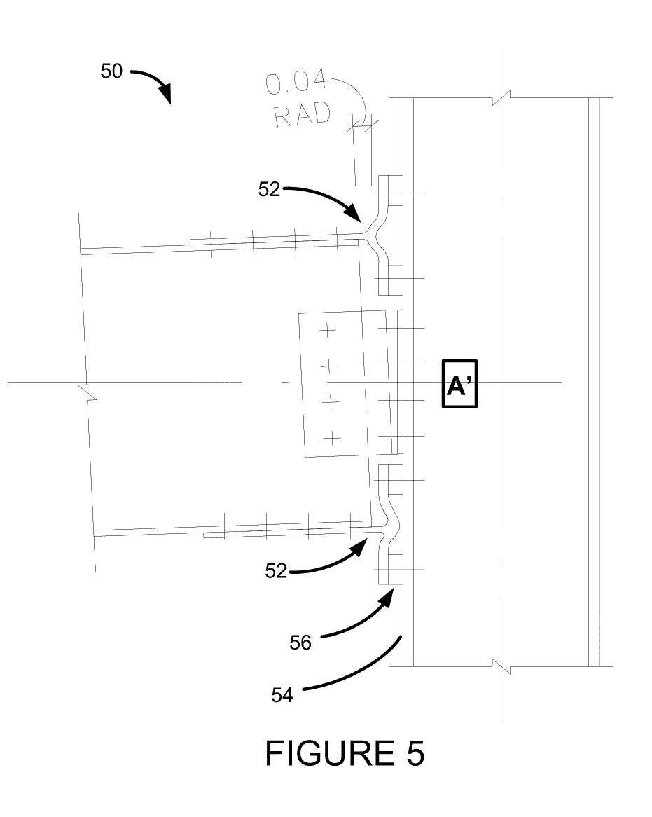

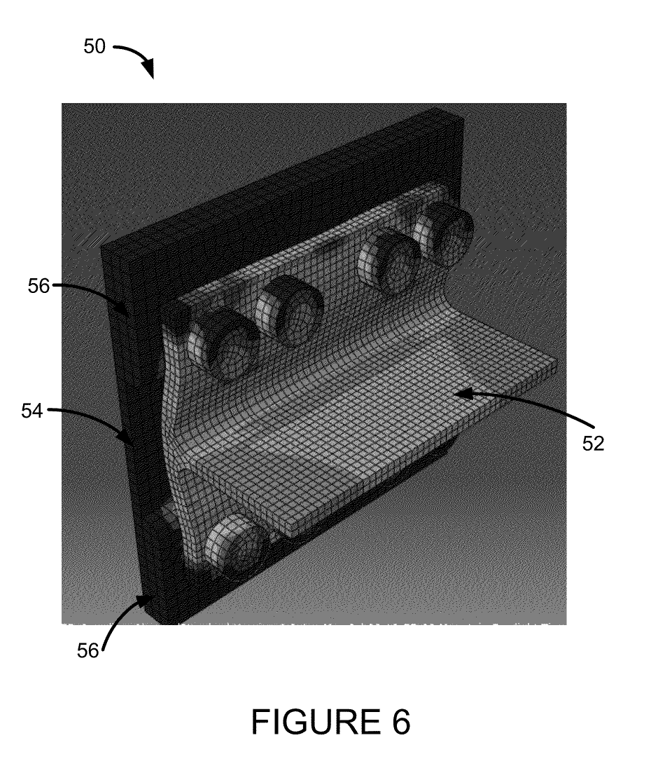

An example of an extension for a beam to column connection 50 within a structure is illustrated in FIG. 5 and FIG. 6. FIG. 5, for example, shows a spaced (e.g., shimmed) connection rotation, and FIG. 6 shows an example spaced (e.g., shimmed) WT connection in which a T-shaped bracket 52 is undergoing deformation towards a column face 54 between spacers 56.

In the example extension shown in FIGS. 5 and 6, a T-shaped bracket 52, such as a WT, is spaced from a column face 54 by a pair of spacers (e.g., shims) to position a T-shaped bracket flange away from a column flange. In this implementation, this permits a point of rotation at A′ to be located near mid height. For a prescribed or target rotation demand, e.g., 0.04 radians used by the American Institute for Steel Construction, the amount of inelastic deformation demanded of the WT is decreased by approximately 50% as compared to the traditional connection. As illustrated in FIG. 6, the WT can now move toward the column flange. The spacer can be appropriately sized to avoid the WT flange bearing on the column flange.

Although FIGS. 5 and 6 show rotation under moment in the beam, translation of the beam may additionally or alternatively occur under axial forces in the beam.

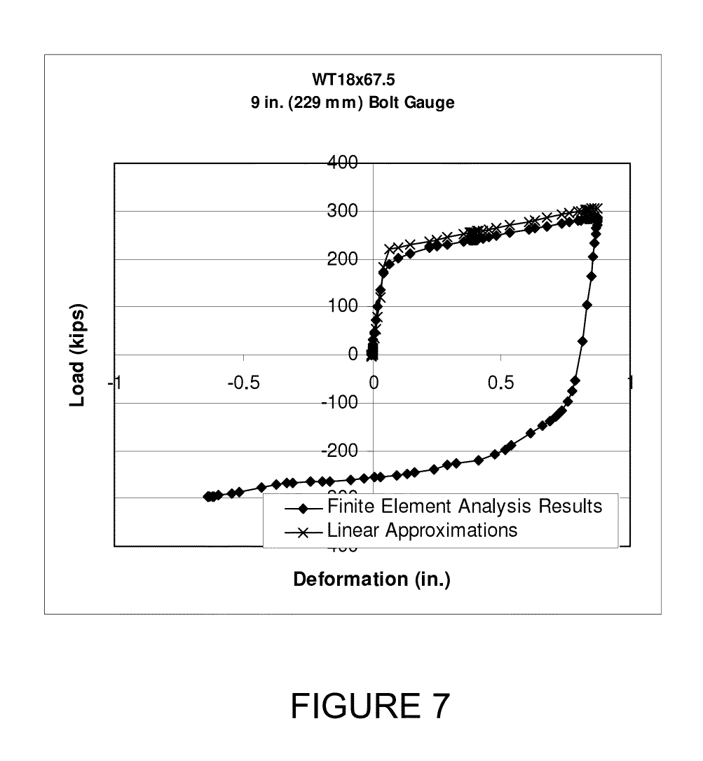

FIG. 7 illustrates preliminary modeling results depicting movement of the WT away and toward the column in an example spaced connection cyclic load-deformation plot.

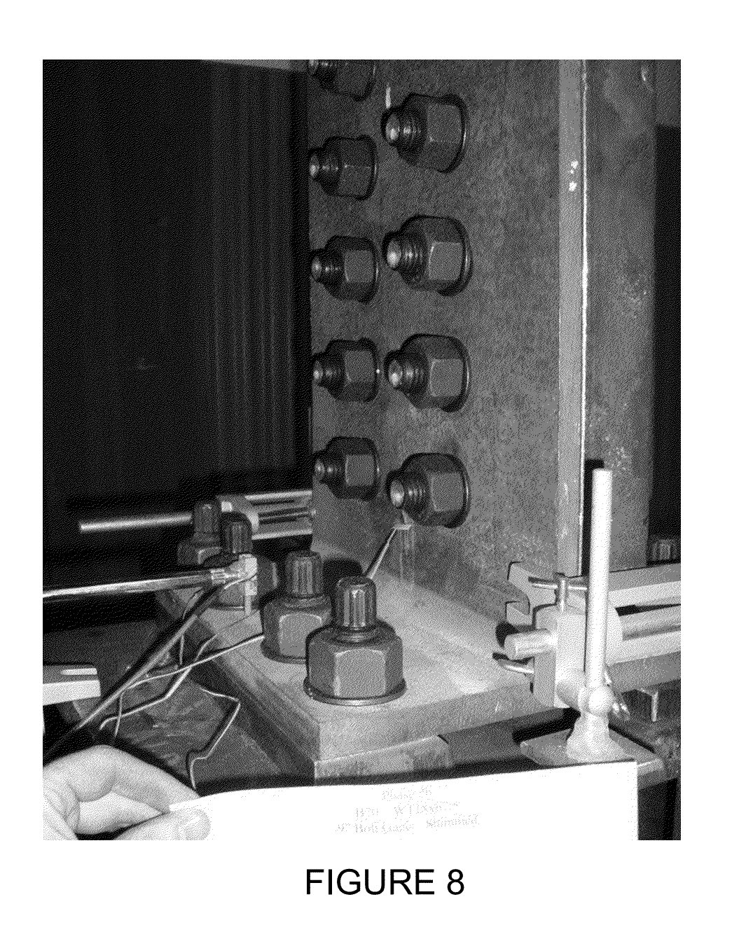

The area under the curve shown in FIG. 7 is the energy absorbed by a T-shaped bracket and would be energy absorbed during a seismic event. Also important in this example, the shimmed connection minimizes the deformation demand on the WT, angle, or plate components attached to the beam web, designed to carry shear forces. The connection to the beam web can deform but must continue to carry load during and after the earthquake. This is not of major concern as other shear connections within the building (common design practice) will sustain the same movements. Finally, an example specimen prior to testing is shown in FIG. 8 for a testing phase 2b WT 18×67.5.

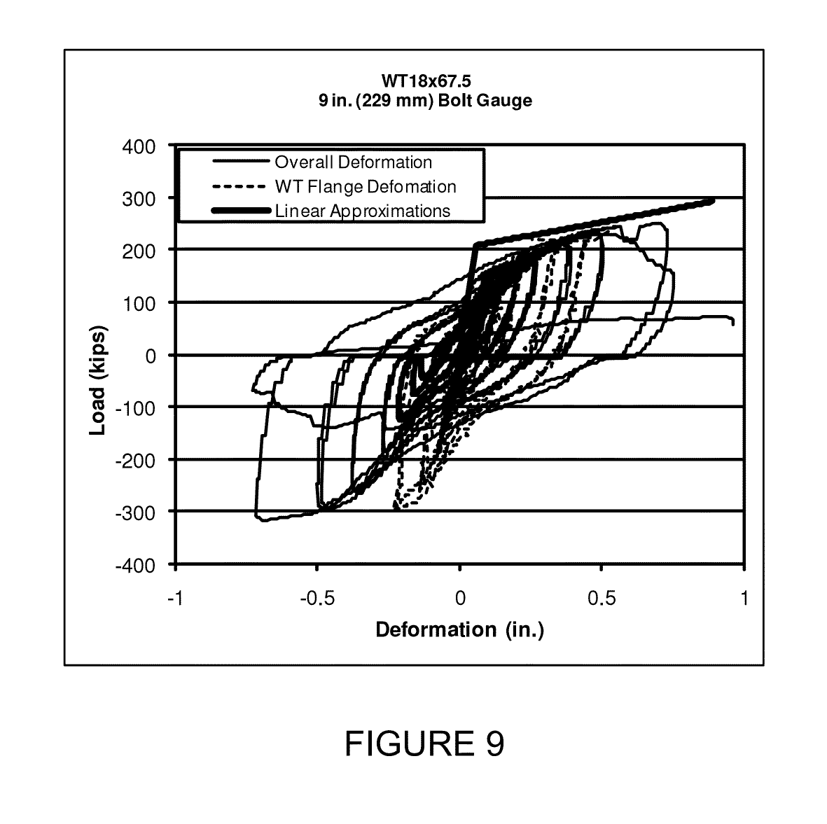

Test results and associated load-deflection results are shown in FIG. 9. FIG. 9, for example, shows a load-deformation comparison for the testing phase 2b WT 18×67.5 test example. This demonstrates significant ductility and ability to absorb energy from a seismic event.

Various aspects of the connections described herein are further described in McManus, P. M. (2010). “Economic and Serviceable Structural Steel Seismic Load Resisting Systems,” In partial fulfillment of the requirement for the Ph.D., Department of Civil and Architectural Engineering, University of Wyoming, Laramie, Wyo., which is hereby incorporated by reference in its entirety as though fully set forth herein.

Although one implementation of this invention have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joiner references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention. Changes in the materials may be made without departing from the spirit of the invention. For example, materials might be cast, rolled, welded, etc. and could be, e.g., steel, aluminum, plastic, elastomeric, fiber reinforced plastic and so forth. Similarly, while in most examples described separate spacers (e.g., shims) are used with standard WT beams, other implementations are also possible. For example, the shims could be unitary or otherwise incorporated with a bracket or member (e.g., a beam or column), such as by casting or otherwise forming the beam and spacers as a single component.

What is claimed is:

1. A primary member-to-primary member connection comprising:
a support bracket having a first support bracket face;
a first support member comprising a first support member face for connecting to the support bracket to support a second support member; and
a spacer disposed between the first support bracket face and the first support member face, wherein the spacer is disposed and configured to allow deformation of the first support bracket face at least toward the first support member face in response to a load.

2. The primary member-to-primary member connection of claim 1 wherein the deformation comprises inelastic deformation.

3. The primary member-to-primary member connection of claim 1 wherein the support bracket comprises a T-shaped bracket for coupling the second support member to the first support member via the first support member face.

4. The primary member-to-primary member connection of claim 3 wherein the T-shaped bracket comprises one or more of the group comprising a welded T-shaped bracket, a cast T-shaped bracket, an extruded bracket, a milled bracket, a machined bracket, and a WT bracket.

5. The primary member-to-primary member connection of claim 1 wherein the load comprises a seismic load.

6. The primary member-to-primary member connection of claim 1 wherein the load comprises one or more of the group comprising a blast load, a wind load, a thermal load, a gravity load, a soil load, and a displacement load due to an environmental effect.

7. The primary member-to-primary member connection of claim 1 wherein the spacer comprises a pair of spacers.

8. The primary member-to-primary member connection of claim 7 wherein the pair of spacers are disposed adjacent to opposing flanges of the bracket along the first support bracket face to allow the support bracket to deform along the first support bracket face at least toward the first support member face between the pair of spacers in response to the load.

9. The primary member-to-primary member connection of claim of claim 7 wherein the pair of spacers are integral with at least one of the support bracket and the first support member.

10. The primary member-to-primary member connection of claim 7 wherein the pair of spacers comprise at least one of the group comprising a shim, a washer, a ring, plate, bar, pad, and round.

11. The primary member-to-primary member connection of claim 1 wherein the spacer is integral with at least one of the support bracket and the first support member.

12. The primary member-to-primary member connection of claim 1 wherein the spacer comprises at least one of the group comprising a shim, a washer, a ring, plate, bar, pad, and round.

13. The primary member-to-primary member connection of claim 1 wherein the first support member comprises a column and the second support member comprises a beam or the first support member comprises a beam and the second support member comprises a column.

14. The primary member-to-primary member connection of claim 1 further comprising a shear connection coupling the first support member and the second support member.

15. A primary member-to-primary member connection comprising:
a first support member comprising opposing sides;
a pair of support brackets each comprising a support bracket face, wherein each of the pair of support brackets is coupled to one of the opposing sides of the first support member;
a second support member comprising a second support member face for connecting to the pair of support brackets to support the first support member; and
a spacer disposed between each support bracket face of the pair of support brackets and the second support member face, wherein spacers are disposed and configured to allow deformation of at least one of the support bracket faces at least toward the second support member face in response to a load.

16. The primary member-to-primary member connection of claim 15 wherein the deformation comprises inelastic deformation.

17. The primary member-to-primary member connection of claim 15 wherein each of the pair of support brackets comprises a T-shaped bracket for coupling the first support member to the second support member via the second support member face.

18. The primary member-to-primary member connection of claim 17 wherein the T-shaped brackets comprises one or more of the group comprising a welded T-shaped bracket, a cast T-shaped bracket, an extruded bracket, a milled bracket, a machined bracket, and a WT bracket.

19. The primary member-to-primary member connection of claim 15 wherein the load comprises one or more of the group comprising a seismic load, a blast load, a wind load, a thermal load, a gravity load, a soil load, and a displacement load due to an environmental effect.

20. The primary member-to-primary member connection of claim 15 wherein each of the spacers comprises a pair of spacers.

21. The primary member-to-primary member connection of claim 20 wherein each of the pair of spacers are disposed adjacent opposing flanges of one of the pair of support brackets along the support bracket face to allow the support bracket to deform along the first support bracket face at least toward the second support member face between the pair of spacers in response to the load.

22. The primary member-to-primary member connection of claim 15 wherein each of the spacers is integral with at least one of the support brackets and the second support member.

23. The primary member-to-primary member connection of claim 1 wherein the first support member comprises a column and the second support member comprises a beam or the first support member comprises a beam and the second support member comprises a column.

24. The primary member-to-primary member connection of claim 1 further comprising a shear connection coupling the first support member and the second support member.

25. A method of providing a primary member-to-primary member connection comprising:
coupling a pair of support brackets to opposing sides of a first support member, each of the pair of support brackets comprising a support face; and
coupling the pair of support brackets to a second support member along a second support member face, wherein the support faces of the pair of support brackets are disposed generally opposing the second support member face of the second support member and the second support member face is separated from the respective support bracket faces of the pair of support brackets by at least one spacer configured to allow deformation of at least one of the support bracket faces at least toward the second support member face in response to a load.

26. The method of claim 25 wherein the first support member comprises a column and the second support member comprises a beam or the first support member comprises a beam and the second support member comprises a column.

27. The method of claim 25 further comprising coupling the first support member and the second support member via a shear connection.
